(19) United States
(12) Patent Application Publication
(10) Pub. No.: US 2019/0188709 A1
(43) Pub. Date: Jun. 20, 2019

(54) PAYMENT HANDLING APPARATUS AND METHOD

(71) Applicant: COMCARDE LIMITED, Edinburgh (GB)

(72) Inventors: Stuart JAMIESON, Edinburgh (GB); Ian SIDOR, Edinburgh (GB)

(21) Appl. No.: 16/326,341

(22) PCT Filed: Aug. 21, 2017
(86) PCT No.: PCT/GB2017/052471

§ 371 Date: Feb. 18, 2019

(30) Foreign Application Priority Data
Aug. 24, 2016 (GB) 1614419.8

(51) Int. Cl. G06Q 20/40; G06Q 20/10; G06Q 20/38; G06Q 20/32

(52) U.S. Cl. CPC G06Q 20/40; G06Q 20/3226; G06Q 20/385; G06Q 20/10

(57) ABSTRACT

The present invention relates to payment handling apparatus (10) which is operable to effect payment from a purchaser to a vendor. The payment handling apparatus (10) comprises a purchaser client (12) operable by the purchaser and a vendor client (16) operable by the vendor, the vendor client being in data communication with the purchaser client. The payment handling apparatus (10) also comprises a purchaser server (14) in data communication with the purchaser client (12) and a vendor server (18) in data communication with the vendor client (16) and the purchaser server (14). The purchaser client (12) and the purchaser server (14) being configured such that under purchaser operation the purchaser client is operative to receive from the purchaser server an authorisation code for a payment to be made by the purchaser to the vendor. The purchaser client (12) and the vendor client (16) being configured such that the vendor client is operative in dependence on purchaser operation to receive a purchase code from the purchaser client. The vendor (server 18) and the purchaser server (14) being configured such that the purchaser server is operative to receive the purchase code from the vendor client (16) by way of the vendor server. The purchaser server (14) and the vendor server (18) being configured to effect payment in dependence on receipt by the purchaser server of the purchase code and on receipt by the purchaser client (12) of the authorisation code.

### FIELD OF THE INVENTION

The present invention relates to a payment handling apparatus which is operable to effect payment from a purchaser to a vendor. The present invention also relates to a payment handling method which effects payment from a purchaser to a vendor.

### BACKGROUND ART

Arrangements for making payments by way of a mobile device are known. According to one longer used approach, the vendor has apparatus comprising a handheld device such as a smartphone and a credit/debit card reader. The handheld device and the credit/debit card reader are in data communication and normally wireless data communication with each other such as by way of Bluetooth. Payment for goods or services is accomplished by the vendor entering the transaction details including the cost of the goods or services into the apparatus before the purchaser's credit/debit card is read by the credit/debit card reader and the purchaser authorises payment by entering a PIN associated with the credit/debit card.

More recently approaches to making payments without operative use of a credit/debit card have been introduced. One such approach involves the purchaser entering credit/debit card data into the vendor's mobile device or into a client process running on the purchaser's device which is controlled over the Internet by a vendor process. This approach relies on underlying card payment infrastructure. A further known approach involves the purchaser logging into his banking application before the vendor passes a code containing payment details including the vendor's banking details to the purchaser. The purchaser then enters the code into the banking application which is then operative by way of data communication with the vendor's bank server to effect payment to the vendor such as by way of a faster Automated Clearing House (ACH) payment.

The present inventors have appreciated the above described known approaches to involve time delay. Under some circumstances the time delay may be of insufficient duration or the circumstances may be such that the time delay is not considered an issue. However under other circumstances prompt payment processing is an advantage such as where there are a large number of payments to be processed within a short time by a vendor or where the vendor's payment infrastructure is handling a large volume of payments at any one time on account of other vendors' shared use of the payment infrastructure. The present invention has been devised in light of this appreciation. It is therefore an object for the present invention to provide improved payment handling apparatus which is operable to effect payment from a purchaser to a vendor. It is a further object for the present invention to provide an improved payment handling method which effects payment from a purchaser to a vendor.

### STATEMENT OF INVENTION

According to a first aspect of the present invention there is provided payment handling apparatus which is operable to effect payment from a purchaser to a vendor, the payment handling apparatus comprising:
a purchaser client operable by the purchaser;
a vendor client operable by the vendor, the vendor client being in data communication with the purchaser client;
a purchaser server in data communication with the purchaser client; and
a vendor server in data communication with the vendor client and the purchaser server,
the purchaser client and the purchaser server being configured such that under purchaser operation the purchaser client is operative to receive from the purchaser server an authorisation code for a payment to be made by the purchaser to the vendor,
the purchaser client and the vendor client being configured such that the vendor client is operative in dependence on purchaser operation to receive a purchase code from the purchaser client,
the vendor server and the purchaser server being configured such that the purchaser server is operative to receive the purchase code from the vendor client by way of the vendor server,
the purchaser server and the vendor server being configured to effect payment in dependence on receipt by the purchaser server of the purchase code and on receipt by the purchaser client of the authorisation code.

The payment handling apparatus comprises a purchaser client which is operable by a purchaser, a vendor client which is operable by a vendor with the vendor client being in data communication with the purchaser client, for example by way of Bluetooth. The purchaser client may be comprised in an application resident on the purchaser's mobile device. The payment handling apparatus further comprises a purchaser server which is in data communication with the purchaser client and a vendor server which is in data communication with the vendor client and the purchaser server. The purchaser client and the purchaser server are configured such that under purchaser operation, such as by way of purchaser operation of his mobile device, the purchaser client is operative to receive from the purchaser server an authorisation code for a payment to be made by the purchaser to the vendor. For example the purchaser may decide to make a purchase from the vendor and therefore the purchaser enters into the purchaser client details of the purchase to be made, such as at least the purchase price. The purchaser client may then be operative to send an authorisation code request to the purchaser server. The purchaser server may then be operative to determine whether or not payment can be made such as by determining whether or not sufficient funds are available to cover the proposed payment. Thereafter the authorisation code may be sent by the purchaser server to the purchaser client. The authorisation code may correspond to one of approval to pay or disapproval to pay. Where the authorisation code corresponds to approval to pay, the purchaser client may be operative to proceed further with the payment process as described below. The process thus far may be carried out prior to the purchaser client engaging with the vendor client with subsequent steps being carried out following engagement of the purchaser client with the vendor client. Carrying out the process thus far may therefore simplify the following payment process and thereby reduce the time involved in the payment process following engagement of the purchaser client with the vendor client. The aforementioned problems with known payment handling apparatus may thus be addressed.

The step of the purchaser client receiving the authorisation code from the purchaser server may be achieved without data communication between the purchaser server and the vendor client and between the vendor client and the purchaser client. Alternatively or in addition, the step of the purchaser client receiving the authorisation code from the purchaser server may be achieved without data communication between the purchaser client and the vendor server and between the purchaser server and the vendor server.

The purchaser client may be configured to restrict payment. As mentioned above, the amount of payment may be restricted in respect of funds available for a purchase following communication between the purchaser client and purchaser server. Alternatively or in addition, the purchaser client may be configured to restrict payment in dependence on operation of the purchaser client. Payment may be restricted in respect of at least one of: maximum spend for one transaction or perhaps plural transactions over a predetermined period; location such as in a predetermined country or city; and vendor such as in respect of at least one predetermined vendor. The purchaser client may be configured, such as by way of a set-up menu, such that a user and perhaps a user with administrator privileges, such as a parent, is able to configure the purchaser client in respect of at least one restriction. Where a restriction is in respect of location, the purchaser client may be operative in dependence on location information to allow or bar a purchase. Location information may be by way of GPS data such as GPS data received in a mobile device on which the purchaser client is operative.

The purchaser client may be operative to convey the authorisation code request to purchaser server. The purchaser server may be operative to convey the authorisation code to the purchaser client in dependence on receipt of the authorisation code request. The purchaser client and the purchaser server may be operative to hand-shake with each other so as to provide a secure communication channel therebetween. For example the purchaser client and the purchaser server may be operative to hand-shake with each other by a cryptographic protocol such as Transport Layer Security (TLS) or its predecessor Secure Sockets Layer (SSL).

The purchaser client and the vendor client of the payment handling apparatus are configured such that under purchaser operation the vendor client is operative to receive a purchase code from the purchaser client. The purchase code may comprise at least one of: the purchase price; identification of the product; and a unique transaction identifier. The unique transaction identifier may have been received from the purchaser server and more specifically may have been comprised in the authorisation code. The step of the vendor client receiving the purchase code may take place when the purchaser client and the vendor client engage with each other. For example, following the step above of the purchaser operating his purchaser client whereby the authorisation code is received from the purchaser server in the purchaser client, the purchaser approaches the point of sale and the purchaser client and the vendor client engage with each other whereby communication takes place between the purchaser client and the vendor client. Communication between the purchaser client and the vendor client may be wireless such as in accordance with the Bluetooth standard, by way of optical transfer or by way of the Internet. Alternatively the purchaser may read the purchase code from the purchaser client for the benefit of the vendor and the vendor may enter the heard purchase code into the vendor client. The purchaser client and the vendor client may therefore be in data communication albeit by way of the purchaser and the vendor.

The vendor server and the purchaser server of the payment handling apparatus are configured such that the purchaser server is operative to receive the purchase code from the vendor client by way of the vendor server. The step of receipt of the purchase code in the purchaser server may be in dependence on receipt in the vendor client of the purchase code. The purchase code may thus be passed from the purchaser client to the vendor client and then passed from the vendor client to the purchaser server by way of the vendor server.

Each of: the vendor client and the vendor server; and the vendor client and the purchaser client may be operative to hand-shake with each other so as to provide a secure communication channel therebetween. For example hand-shaking may be way of a cryptographic protocol such as Transport Layer Security (TLS) or its predecessor Secure Sockets Layer (SSL).

Thereafter the purchaser server and the vendor server are configured to effect payment in dependence on receipt by the purchaser server of the purchase code. Payment may be made in accordance with a known approach such as a faster Automated Clearing House (ACH) payment, a BACs transaction or a SWIFT transaction.

The purchaser and vendor servers are in data communication to effect payment of a sum from the purchaser's bank account to the vendor's bank account. The vendor server may be operative to send a request to pay message to the purchaser server. The request to pay message may comprise the unique transaction identifier and the sum to be paid. The unique transaction identifier and the sum to be paid may be received from the vendor client. Where vendor identification information is received by the vendor server from the vendor client, the request to pay message may further comprise vendor identification information. The request to pay message may further comprise bank information for the vendor such as at least one of the sort code, the account number and the account name. Upon receipt of the unique transaction identifier comprised in the request to pay message the purchaser server may be operative to match the unique transaction identifier comprised in the request to pay message with the transaction identifier received from the purchaser client by way of the vendor client. A positive match between the two unique transaction identifiers may serve at least in part for authentication of the request to pay message. Payment of the sum from the purchaser's bank account to the vendor's bank account may therefore be effected in dependence on a positive match between the two transaction identifiers.

Alternatively or in addition, communication such as between the purchaser client and the purchaser server may be electronic communication.

Alternatively or in addition, communication between the purchaser client and the vendor client may be wireless. According to one approach communication may be in accordance with the Bluetooth protocol. According to another approach, communication may comprise near field communication. The purchaser client may therefore comprise near field communication transceiver apparatus. The vendor client may comprise near field communication transceiver apparatus. The near field communication transceiver apparatus may provide for radio frequency communication of data between the purchaser client and the vendor client.

After payment of the sum from the purchaser's bank account to the vendor's bank account has been effected, the payment handling apparatus may be operative to terminate the unique transaction identifier. More specifically the unique transaction identifier may be designated as expired whereby a message comprising the terminated transaction identifier is not acted upon. Alternatively the unique transaction identifier may be deleted whereby a message comprising the now deleted transaction identifier is not acted upon. The unique transaction identifier may therefore exist for a comparatively short period of time and may thus present a reduced risk for breach of data security.

After payment of the sum from the purchaser's bank account to the vendor's bank account has been effected, the purchaser server may be operative to send a payment complete message to the vendor server. The purchaser payment complete message may comprise the unique code and the amount paid. In addition the payment complete message may comprise at least one of the purchaser's name and the vendor's name.

The payment handling apparatus may comprise plural purchaser clients. In a typical application the payment handling apparatus may comprise many purchaser clients at any one time. Payment may be effected in respect of each of the plural purchaser clients at the same time and in particular with respect to the step of the purchaser client receiving the authorisation code from the purchaser server. At different times payment may be effected in respect of different purchaser servers and different vendor servers. The identity of a purchaser server or a vendor server may depend on the identity of the payment handling establishment engaged by the purchaser or vendor. For example one purchaser may engage a first bank and another purchaser may engage a second bank. Indeed the payment handling apparatus may be configured such that each of plural purchasers or vendors engages a different payment handling establishment at any one time. By way of further example the payment handling establishment may be a clearing bank, a credit/debit card handling establishment, an acquiring bank, etc. At least one of the purchaser server and the vendor server may comprise the payment handling establishment. The payment handling establishment may, for example, be a credit card handling establishment such that payment is made on behalf of the purchaser with actual settlement of the sum being paid by the purchaser at a later time. The purchaser server and the vendor server being configured to effect payment in dependence on receipt by the purchaser server of the purchase code and on receipt by the purchaser client of the authorisation code may be such that, in use, at least one step is taken towards making payment. The payment handling apparatus may comprise at least one of plural purchaser servers and plural vendor servers. Where the payment handling apparatus comprises client apparatus and server apparatus the client apparatus and server apparatus may be at locations spaced apart from each other. Where the payment handling apparatus comprises purchaser server apparatus and vendor server apparatus, the purchaser server apparatus and the vendor server apparatus may be at locations spaced apart from each other.

At least one of the purchaser client and the vendor client may be operable on client apparatus. The payment handling apparatus may comprise at least one such client apparatus. A client may be operable on at least one of a Personal Computer, such as a laptop, and a mobile computing device, such as a tablet computer or a smartphone. At least one of the purchaser server and the vendor server may be operable on server apparatus. The payment handling apparatus may comprise at least one such server apparatus.

The purchaser and the vendor may engage the same payment handling establishment, for example the same bank. The purchaser server and the vendor server may therefore be comprised in the same server apparatus. Server apparatus may be distributed such that a purchaser related process is operative on a first part of the server apparatus and a vendor related process is operative on a second part of the server apparatus. Indeed a purchaser or server related process may be operative on different parts of server apparatus at different times. Alternatively or in addition, first and second parts of a purchaser or server related process may be operative on different parts of server apparatus during the course of effecting payment of one sum from the purchaser's bank account to the vendor's bank account.

A server, for example the purchaser server or the vendor server, may comprise a server application. Where communication is by way of the Internet the server application may comprise a web server. A client, for example the purchaser client or the vendor client, may be configured to run a client application. Where communication is by way of the Internet the client application may comprise a web client. The purchaser application may be operative to provide the functions and operations described above. Communication between a client and a server may be by way of at least one of: a computer network, such as the Internet; and a metropolitan or wide area network, such as the Global System for Mobile Communications (GSM) network or 4G. Communication between the purchaser server and the vendor server may be by way of a communications link, for example a dedicated communications link or a computer network, such as the Internet. A client, for example the purchaser client or the vendor client, may be configured to provide a dialog box. The dialog box may be a web browser window. The dialog box may be displayed on a display surface of client apparatus, such as a display screen of a mobile computing device. The dialog box may provide for reciprocal communication between a client process and a user. The dialog box may comprise at least one user operable component, such as a clickable or touch sensitive area, which is operative to provide for entry of data and control by a user.

Apparatus according to the present invention may be integrated with proprietary product ordering apparatus and processes. For example a proprietary product ordering process may comprise completion by a purchaser of a written order which is then handed to a point of sale for payment to be made. When payment is made the purchaser is given a unique product reference and the unique product reference and product detail are passed to a warehouse where the product is selected and conveyed to a delivery location. When the product arrives at the delivery location the unique product reference is displayed whereby the purchaser is notified that his purchase is ready for collection. Integration of the present invention may comprise communication of the purchaser client with the proprietary product ordering apparatus following the step of the purchaser client receiving an authorisation code corresponding to approval to pay from the purchaser server. Thereupon the payment code may be conveyed to the proprietary product ordering apparatus whereupon the proprietary product ordering apparatus is operative to provide for selection of the product and conveyance to the delivery location. Notification to the purchaser of the purchase being ready for collection is by way of the unique transaction identifier comprised in the payment code received from the purchaser client.

According to a second aspect of the present invention there is provided a payment handling method which effects payment from a purchaser to a vendor, the method comprising:
receiving in a purchaser client from a purchaser server an authorisation code for a payment to be made by the purchaser to the vendor, the authorisation code being received in dependence on purchaser operation of the purchaser client;
receiving in a vendor client a purchase code from the purchaser client in dependence on purchaser operation of the purchaser client;
receiving the purchase code in the purchaser server from the vendor client by way of the vendor server; and
effecting payment from the purchaser to the vendor in dependence on receipt by the purchaser server of the purchase code and on receipt by the purchaser client of the authorisation code.

Embodiments of the second aspect of the present invention may comprise one or more features of the first aspect of the present invention.

According to a third aspect of the present invention there is provided a computer program comprising program instructions for causing computer apparatus to perform the method according to the second aspect of the present invention. More specifically, the computer program may be at least one of: embodied on a record medium; embodied in read only memory; stored in a computer memory; and carried on an electrical carrier signal. Further embodiments of the third aspect of the present invention may comprise one or more features of the first aspect of the present invention.

According to a fourth aspect of the present invention there is provided a computer system comprising program instructions for causing computer apparatus to perform the method according to the second aspect of the present invention. More specifically the program instructions may be at least one of: embodied on a record medium; embodied in a read only memory; stored in a computer memory; and carried on an electrical carrier signal. Further embodiments of the fourth aspect of the present invention may comprise one or more features of the first aspect of the present invention.

According to a further aspect of the present invention there is provided payment handling apparatus which is operable to effect payment from a purchaser to a vendor, the payment handling apparatus comprising: a purchaser client operable by the purchaser; a vendor client operable by the vendor, the vendor client being in data communication with the purchaser client; a purchaser server which is in data communication with the purchaser client and the vendor client; and a vendor server which is in data communication with the vendor client and the purchaser server, the purchaser server and the vendor server being configured to effect payment in dependence on receipt by the purchaser server of a purchase code. Embodiments of the further aspect of the present invention may comprise one or more features of the first aspect of the present invention.

### BRIEF DESCRIPTION OF DRAWINGS

Further features and advantages of the present invention will become apparent from the following specific description, which is given by way of example only and with reference to the accompanying drawings, in which:

FIG. 1 is a block diagram representation of payment handling apparatus according to the present invention; and

FIG. 2 is a flow chart representation of steps of operation of the payment handling apparatus of FIG. 1.

### DESCRIPTION OF EMBODIMENTS

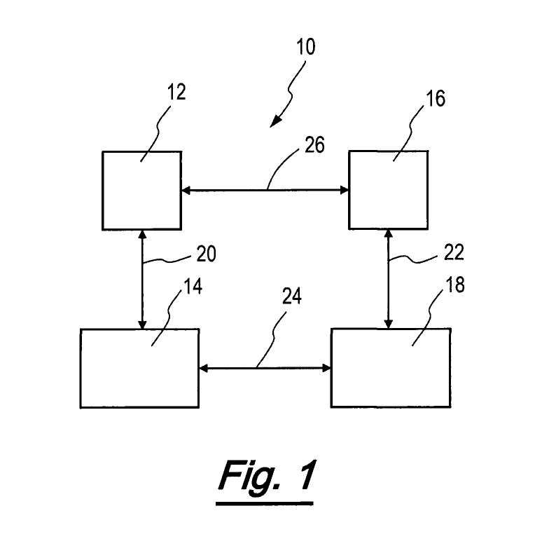

A block diagram representation of payment handling apparatus 10 according to the present invention is shown in FIG. 1. The payment handling apparatus 10 comprises a purchaser client 12, a purchaser server 14, a vendor client 16 and a vendor server 18. The purchaser client 12 is a process operative on mobile computing apparatus owned by a purchaser, such as a tablet computer or more typically a smartphone. The vendor client 16 is a process operative on computing apparatus owned by a vendor, such as a laptop computer, a tablet computer or a PC based till. The purchaser server 14 is comprised in purchaser server apparatus operated by a payment processing authority such as a bank. Typically the purchaser server apparatus has a distributed architecture. Likewise the vendor server 18 is comprised in vendor server apparatus operated by a payment processing authority such as a bank. Again the vendor server apparatus typically has a distributed architecture. Communication of data between the purchaser client 12 and the purchaser server 14 is by way of a computer network 20, such as the Internet or a metropolitan or wide area network 20, such as the Global System for Mobile Communications (GSM) or 4G network. Likewise communication of data between the vendor client 16 and the vendor server 18 is by way of a computer network 22, such as the Internet, or a metropolitan or wide area network 22, such as the Global System for Mobile Communications (GSM) or 4G network. Communication between the purchaser server 14 and the vendor server 18 is by way of a communications link 24, for example a dedicated communications link or a computer network, such as the Internet. Under certain circumstances a dedicated communications link is preferred on account of the greater level of security afforded in comparison to a more open Internet based communications link. Communication of data between the purchaser client 12 and the vendor client 16 is by way of a wireless communication link 26 such as in accordance with the Bluetooth standard or by way of a near field communication link.

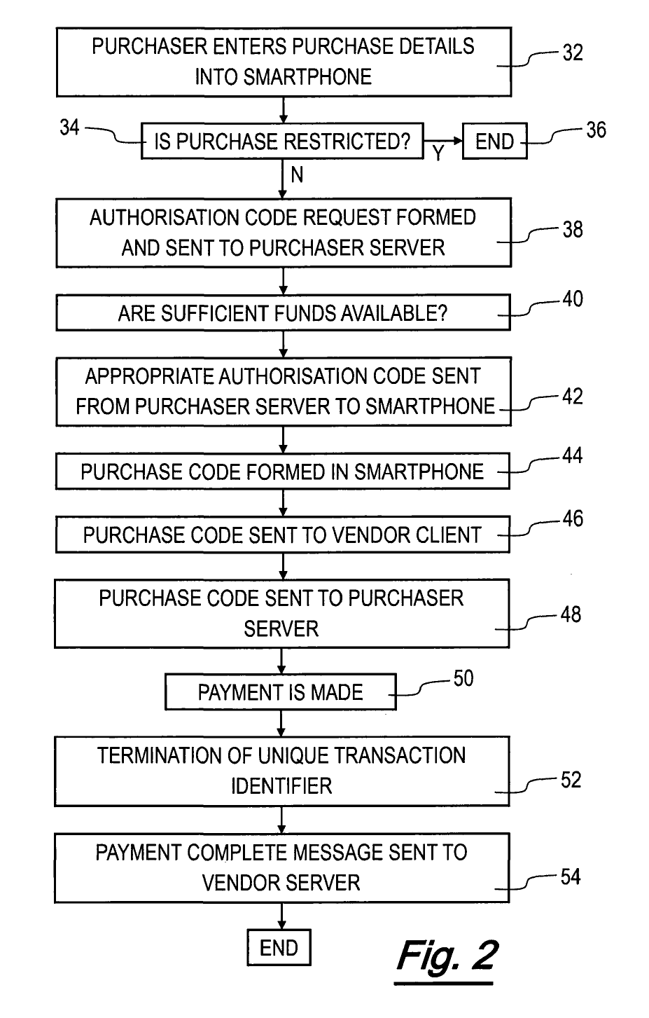

Operation of the payment handling apparatus 10 of FIG. 1 in accordance with the present invention will now be described with reference to FIG. 2 which is a flow chart representation of steps of operation of the payment handling apparatus 10. A purchaser decides upon a purchase, such as an item in a retail outlet. Before going to the vendor's point of sale in the retail outlet, the purchaser gains authorisation for the prospective purchase by the immediately following steps.

The purchaser initiates an authorisation process by operating his smartphone which is running a dedicated client application 12 (which constitutes a purchaser client). The client application is operative to display a dialog box on a display screen of the smartphone. The dialog box is configured to provide for reciprocal communication between the client application and the purchaser. In accordance with normal design practice for smartphone applications, the dialog box comprises touch sensitive areas which are operable by the purchaser to provide for entry of data and control of the client application by the purchaser. The purchaser enters by way of the dialog box details of the prospective purchase which at least includes the purchase price 32. In forms of the invention the purchaser client is configured to restrict payment under certain predetermined circumstances 34. The purchaser client is configured to restrict payment by way of a set-up menu such that a user with administrator privileges, such as a parent, is able to configure the purchaser client in respect of at least one restriction. By way of a first example, a restriction is in respect of maximum expenditure for one transaction. By way of a second example, a restriction is in respect of the total expenditure for plural transactions over a predetermined period such as a day or a week. By way of a third example, a restriction is in respect of location such as in a predetermined country or city. Where a restriction is in respect of location, the purchaser client is operative in dependence on location information to allow or bar a purchase, with location information being provided by way of GPS data received in the mobile computing apparatus on which the purchaser client is operative. If a restriction applies, for example if the purchase is proposed away from the predetermined location or in respect of a purchase price that exceeds maximum expenditure for one transaction, the process according to the invention terminates and the purchaser is informed by way of a message on the display of the mobile computing apparatus 36. If no restriction applies, the client application is then operative to form an authorisation code request comprising the purchase price. The client application has been configured to provide for communication with a server of at least one payment processing authority. For example the purchaser may have three bank accounts with different banks. The client application is therefore configured to allow the purchaser to select one of the three bank accounts and to provide for transmission of the authorisation code request to the purchaser server 14 by way of the computer network 20 in dependence on the payment processing authority selection where such selection is performed 38. The purchaser client 12 and the purchaser server 14 are operative to hand-shake with each other by a cryptographic protocol such as Transport Layer Security (TLS) or its predecessor Secure Sockets Layer (SSL). It is to be noted that there is no storage of the purchaser's bank account details in the purchaser client 12 or in the smartphone. Instead the client application is preconfigured by way of secure identification of the client application with the server or servers holding the bank account or bank accounts to which the purchaser wishes to gain access by way of a conventional digital banking software platform.

Upon receipt of the authorisation code request by the purchaser server 14, the purchaser server is operative to determine whether or not sufficient funds are available to cover the proposed payment as contained within the authorisation code request 40. Thereafter the purchaser server is operative to form an authorisation code in dependence on the determination with the authorisation code corresponding to approval to pay if there are sufficient funds available or disapproval to pay if there are insufficient funds available. The purchaser server 14 is then operative to send the authorisation code to the purchaser client 12, 42. It should be noted that the process thus far is carried out prior to the purchaser client engaging with the vendor client and indeed the purchaser engaging with the vendor with subsequent steps being carried out following engagement of the purchaser client with the vendor client. Carrying out the process thus far therefore simplifies the payment process and thereby reduces the time involved in the payment process following engagement of the purchaser client with the vendor client.

Following receipt of the authorisation code, the purchaser client 12 is operative to form a purchase code comprising: the authorisation code; the purchase price; identification of the product; and a unique transaction identifier 44. The unique transaction identifier is comprised in the authorisation code. The purchaser then approaches the point of sale and the purchaser client 12 and the vendor client 16 engage with each other whereby communication can take place between the purchaser client and the vendor client. The purchaser client 12 is then operative to transmit the purchase code to the vendor client 16, 46. Alternatively the purchaser reads the purchase code from the purchaser client 12 for the benefit of the vendor and the vendor enters the heard purchase code into the vendor client 16. Thereafter the vendor client 16 transmits the purchase code to the purchaser server 14 by way of the vendor server 18, 48. Prior to communication, hand-shaking between the vendor client 16 and the vendor server 18 and between the vendor client 16 and the purchaser client 12 is by way of a cryptographic protocol such as Transport Layer Security (TLS) or its predecessor Secure Sockets Layer (SSL).

Payment is made in dependence on receipt by the purchaser server of the purchase code 50. Payment is made in accordance with a known approach such as a faster Automated Clearing House (ACH) payment, a BACs transaction or a SWIFT transaction. Considering payment in more detail, the purchaser server 14 and the vendor server 18 are in data communication to effect payment of a sum from the purchaser's bank account to the vendor's bank account. The vendor server 18 sends a request to pay message to the purchaser server 14. The request to pay message comprise the unique transaction identifier and the sum to be paid which are extracted from the purchase code. Where vendor identification information is received by the vendor server 18 from the vendor client 16, the request to pay message further comprises vendor identification information. The request to pay message further comprises bank information for the vendor such as the sort code, the account number and the account name. Upon receipt of the unique transaction identifier comprised in the request to pay message the purchaser server 14 is operative to match the unique transaction identifier comprised in the request to pay message with the unique transaction identifier sent to the purchaser client 12 in the authorisation code. A positive match between the two unique transaction identifiers serve at least in part for authentication of the request to pay message. Payment of the sum from the purchaser's bank account to the vendor's bank account is therefore effected in dependence on a positive match between the two transaction identifiers.

After payment of the sum from the purchaser's bank account to the vendor's bank account has been effected, the payment handling apparatus is operative to terminate the unique transaction identifier 52. More specifically the unique transaction identifier is designated as expired whereby a message comprising the terminated transaction identifier is not acted upon. Alternatively the unique transaction identifier is deleted whereby a message comprising the now deleted transaction identifier is not acted upon. In addition, the purchaser server 14 is operative to send a payment complete message to the vendor server 18, 54. The purchaser payment complete message comprises the amount paid, the purchaser's name and the vendor's name.

In certain embodiments, the apparatus and process described above is integrated with proprietary product ordering apparatus and processes. By way of example, a proprietary product ordering process comprises the step of completion by a purchaser of a written order which is then handed to a point of sale for payment to be made. When payment is made, the purchaser is given a unique product reference and the unique product reference and product detail are passed to a warehouse where the product is selected and conveyed to a delivery location. When the product arrives at the delivery location, the unique product reference is displayed whereby the purchaser is notified that his purchase is ready for collection. Integration of the apparatus and process described above further comprises providing for communication between the purchaser client and the proprietary product ordering apparatus following the step of the purchaser client receiving an authorisation code corresponding to approval to pay from the purchaser server. Thereupon the payment code is conveyed to the proprietary product ordering apparatus whereupon the proprietary product ordering apparatus is operative to provide for selection of the product and conveyance to the delivery location. Notification to the purchaser of the purchase being ready for collection is by way of the unique transaction identifier comprised in the payment code received from the purchaser client.

1. Payment handling apparatus which is operable to effect payment from a purchaser to a vendor, the payment handling apparatus comprising:
a purchaser client operable by the purchaser;
a vendor client operable by the vendor, the vendor client being in data communication with the purchaser client;
a purchaser server in data communication with the purchaser client; and
a vendor server in data communication with the vendor client and the purchaser server,
the purchaser client and the purchaser server being configured such that under purchaser operation the purchaser client is operative to receive from the purchaser server an authorisation code for a payment to be made by the purchaser to the vendor,
the purchaser client and the vendor client being configured such that the vendor client is operative in dependence on purchaser operation to receive a purchase code from the purchaser client,
the vendor server and the purchaser server being configured such that the purchaser server is operative to receive the purchase code from the vendor client by way of the vendor server,
the purchaser server and the vendor server being configured to effect payment in dependence on receipt by the purchaser server of the purchase code and on receipt by the purchaser client of the authorisation code.

2. Payment handling apparatus according to claim 1, in which the purchaser client is configured to send an authorisation code request to the purchaser server, the authorisation code being sent by the purchaser server to the purchaser client in dependence on receipt of the authorisation code request.

3. Payment handling apparatus according to claim 1, in which receipt of the authorisation code by the purchaser client from the purchaser server is achieved without data communication between the purchaser server and the vendor client and between the vendor client and the purchaser client.

4. Payment handling apparatus according to claim 1, in which receipt of the authorisation code by the purchaser client from the purchaser server is achieved without data communication between the purchaser client and the vendor server and between the purchaser server and the vendor server.

5. Payment handling apparatus according to claim 1, in which the purchaser client is configured to impose a restriction on payment from the purchaser server and the vendor server, the restriction being imposed in dependence on a location of the purchaser client.

6. Payment handling apparatus according to claim 1, in which the purchase code comprises at least one of: the purchase price; identification of the product; and a unique transaction identifier.

7. Payment handling apparatus according to claim 6, in which the unique transaction identifier is comprised in the authorisation code.

8. Payment handling apparatus according to claim 1, in which the purchase code is conveyed to the vendor client by way of a wireless communication channel between the purchaser client and the vendor client.

9. Payment handling apparatus according to claim 1, in which the vendor enters the purchase code into the vendor client by way of operation of the vendor client.

10. Payment handling apparatus according to claim 1, in which the purchase code is conveyed from the vendor client to the purchaser server by way of the vendor server following receipt of the purchase code by the vendor client.

11. Payment handling apparatus according to claim 10 when depending from claim 6, in which the vendor server is configured to send a request to pay message to the purchaser server, the request to pay message comprising the unique transaction identifier and the sum to be paid.

12. Payment handling apparatus according to claim 11, in which vendor identification information is received by the vendor server from the vendor client, the request to pay message further comprising the vendor identification information.

13. Payment handling apparatus according to claim 11, in which the purchaser server is configured to match the unique transaction identifier comprised in the request to pay message with the unique transaction identifier received from the purchaser client by way of the vendor client, a positive match between the two unique transaction identifiers serving at least in part for authentication of the request to pay message.

14. Payment handling apparatus according to claim 6, in which the payment handling apparatus is configured to terminate the unique transaction identifier after payment from the purchaser's bank account to the vendor's bank account has been effected.

15. Payment handling apparatus according to claim 14, in which the unique transaction identifier is designated as expired whereby a message comprising the terminated transaction identifier is not acted upon.

16. Payment handling apparatus according to claim 14, in which the unique transaction identifier is deleted whereby a message comprising the now deleted transaction identifier is not acted upon.

17. Payment handling apparatus according to claim 1 comprising plural purchaser clients, payment being effected in respect of each of the plural purchaser clients at the same time.

18. A payment handling method which effects payment from a purchaser to a vendor, the method comprising:
receiving in a purchaser client from a purchaser server an authorisation code for a payment to be made by the purchaser to the vendor, the authorisation code being received in dependence on purchaser operation of the purchaser client;
receiving in a vendor client a purchase code from the purchaser client in dependence on purchaser operation of the purchaser client;
receiving the purchase code in the purchaser server from the vendor client by way of the vendor server; and
effecting payment from the purchaser to the vendor in dependence on receipt by the purchaser server of the purchase code and on receipt by the purchaser client of the authorisation code.

19. A computer program comprising program instructions for causing computer apparatus to perform the method according to claim 18.

20. The computer program according to claim 19 which is at least one of: embodied on a record medium; embodied in read only memory; stored in a computer memory; and carried on an electrical carrier signal.
